(19) United States
(12) Patent Application Publication
(10) Pub. No.: US 2009/0282647 A1
(43) Pub. Date: Nov. 19, 2009

(54) HINGE ASSEMBLY AND MOBILE COMMUNICATION TERMINAL HAVING THE SAME

(75) Inventors: Seong-Geun Kim, Suwon-si (KR); Sung-Tai Jung, Suwon-si (KR); Ga-Young An, Busan (KR); Seog-Jin Ma, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/338,656

(22) Filed: Dec. 18, 2008

(30) Foreign Application Priority Data
May 13, 2008 (KR) 10-2008-0043819
May 14, 2008 (KR) 10-2008-0044627
Aug. 25, 2008 (KR) 10-2008-0083005

(51) Int. Cl. E05D 5/10; E05D 11/02

(52) U.S. Cl. 16/274; 16/386

(57) ABSTRACT

A hinge assembly and a mobile communication terminal equipped with the hinge assembly are disclosed. The hinge assembly in accordance with an embodiment of the present invention can include: a housing; a fixing cam, which is coupled to the housing and has a cam head and a ramp; a shaft, which is coupled to the fixing cam such that the shaft and the fixing cam can rotate; a torsion spring, which is coupled to the fixing cam on one end and the shaft on the other end; a sliding cam, which is coupled to the shaft, such that the sliding cam is allowed to slide over the shaft along the axial direction, and has a protrusion facing the ramp; and a compression spring, which is interposed between the sliding cam and the shaft such that the sliding cam is compressed toward the fixing cam. By using a cam structure, the present invention can selectively control the rotation of the hinge assembly.

### CROSS-REFERENCE TO RELATED APPLICATIONS

This application claims the benefit of Korean Patent Application No. 10-2008-0044627, No. 10-2008-0043819 and No. 10-2008-0083005, filed with the Korean Intellectual Property Office on May 14, 2008, May 13, 2008 and Aug. 25, 2008, respectively, the disclosure of which is incorporated herein by reference in their entirety.

### BACKGROUND

1. Technical Field

The present invention relates to a hinge assembly and a mobile communication terminal equipped with the hinge assembly.

2. Description of the Related Art

A hinge is a type of bearing that connects two solid objects, typically allowing only a limited angle of rotation between them. In recent years, hinge-like structures have been employed in many types of mobile communication terminals, i.e. mobile phones, and folder-type mobile communication terminals having the structure are now available for sale in the market.

A conventional folder type mobile communication terminal employs a torsion spring that provides a certain torque in the direction of an unfolded configuration such that the user can unfold a folder unit more easily. Therefore, the folder unit always receives the torque in the direction of an unfolded configuration, and consequently, if the mobile communication terminal is not in use, there needs a special holder for maintaining a folded configuration of the folder unit.

However, the special holder, which helps the folder unit to maintain an unfolded configuration, not only increases production costs but is also behind a trend towards smaller mobile communication terminals.

### SUMMARY

The present invention provides a hinge assembly and a mobile communication terminal equipped with the hinge assembly in which rotation can be restricted while in a static position.

An aspect of the present invention provides a hinge assembly. The hinge assembly in accordance with an embodiment of the present invention can include: a housing; a fixing cam, which is coupled to the housing and has a cam head and a ramp; a shaft, which is coupled to the fixing cam such that the shaft and the fixing cam can rotate; a torsion spring, which is coupled to the fixing cam on one end and the shaft on the other end; a sliding cam, which is coupled to the shaft, such that the sliding cam is allowed to slide over the shaft along the axial direction, and has a protrusion facing the ramp; and a compression spring, which is interposed between the sliding cam and the shaft such that the sliding cam is compressed toward the fixing cam.

Here, the cam head can include a curve formed along the circumference.

The hinge can include a damper, which is interposed between the shaft and the housing such that rotation of the shaft is dampened. Here, the damper can include: a core, which is fixed on the shaft; a case, which accommodates the core and is fixed in the housing; and viscous fluid, which is interposed between the core and the case. Here, a blade can be formed on an outer surface of the core, in which the blade has friction with the viscous fluid.

Another aspect of the present invention provides a mobile communication terminal. The mobile communication terminal in accordance with another embodiment of the present invention can include: a base unit; a folder unit, which is coupled to the base unit such that the folder unit and the base unit can rotate; and a hinge assembly, which is interposed between the base unit and the folder unit such that the base unit and the folder unit are coupled to each other and rotate. Here, the hinge assembly can include: a hosing; a fixing cam, which is coupled to the housing, in which the fixing cam has a cam head formed thereon and the cam head includes a ramp being formed along a circumference; a shaft, which is coupled to the fixing cam such that the shaft and the fixing cam can rotate; a torsion spring, which is coupled to the fixing cam on one end and the shaft on the other end; a sliding cam, which is coupled to the shaft such that the sliding cam is allowed to slide over the shaft along the axial direction and includes a protrusion facing the ramp; and a compression spring, which is interposed between the sliding cam and the shaft such that the sliding cam is compressed toward the fixing cam.

Here, the cam head can include a curve formed along the circumference.

The mobile communication terminal can further include a damper, which is interposed between the shaft and the housing such that rotation of the shaft is dampened. Here, the damper can include: a core, which is fixed on the shaft; a case, which accommodates the core and is fixed in the housing; and viscous fluid, which is interposed between the core and the case. Here, a blade can be formed on an outer surface of the core, in which the blade has friction with the viscous fluid.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a mobile communication terminal in accordance with an embodiment of the present invention.

FIG. 2 is a front view of a hinge assembly in accordance with an embodiment of the present invention.

FIG. 3 is an exploded perspective view of a hinge assembly in accordance with an embodiment of the present invention.

FIG. 4 is a perspective view of a sliding cam and a fixing cam in accordance with an embodiment of the present invention.

FIG. 5 through FIG. 7 are front views illustrating how a sliding cam and a fixing cam are operated in accordance with an embodiment of the present invention.

FIG. 8 is a perspective view of a damper in accordance with an embodiment of the present invention.

FIG. 9 is an exploded perspective view of a damper in accordance with an embodiment of the present invention.

FIG. 10 is a plan view of a case in accordance with an embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A hinge assembly and a mobile communication terminal equipped with the hinge assembly in accordance with certain embodiments of the present invention will be described below in detail with reference to the accompanying drawings. For better understanding overall in describing aspects of the present invention, the same reference numerals are used for the same means, regardless of the figure number.

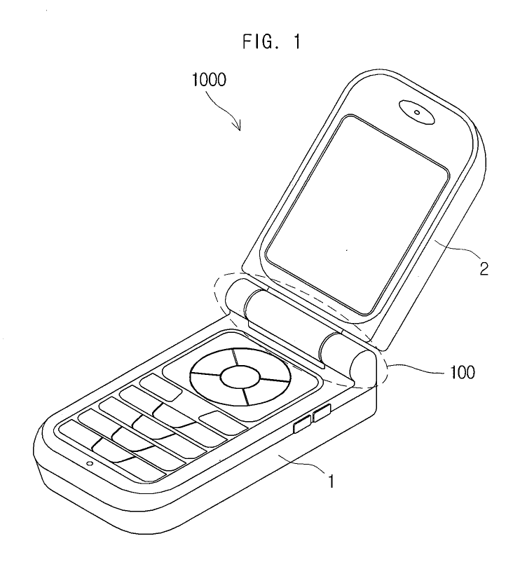

FIG. 1 is a perspective view of a mobile communication terminal in accordance with an embodiment of the present invention. As illustrated in FIG. 1, a mobile communication terminal 1000 in accordance with an embodiment of the present invention includes a base unit 1, a folder unit 2, which is pivotally coupled to the base unit 1, and a hinge assembly 100, which is interposed between the base unit 1 and the folder unit 2 such that the base unit 1 and the folder unit 2 are pivotally coupled to each other. Using a cam structure, the rotation of the hinge assembly 100 can be restricted, and the mobile communication terminal 1000 can maintain its folded state by using this restricted rotation.

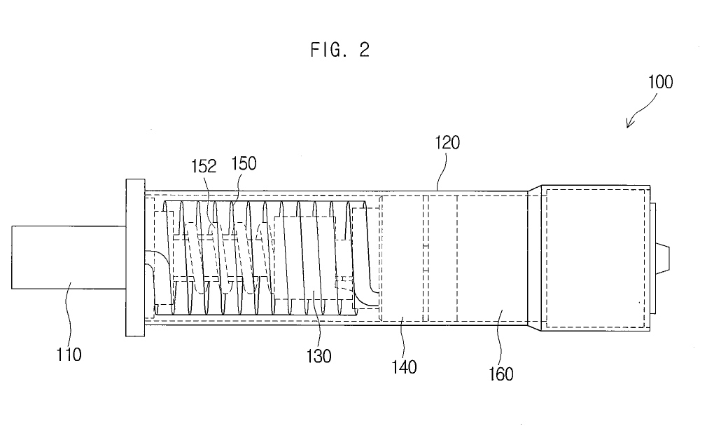

A base unit 1 can house a circuit such as a wireless mobile communication module and have an input unit like dial pads, in order to realize the functionality of the mobile communication terminal 1000. A folder unit 2 can be coupled with a display unit to let a user know the operational state of the mobile communication terminal 1000. The base unit 1 and the folder unit 2 can be pivotally coupled to each other by the hinge assembly 100. FIG. 2 is a front view of a hinge assembly in accordance with an embodiment of the present invention. As illustrated in FIG. 2, a hinge assembly 100 can include a housing 120, a fixing cam 140, which is coupled to the housing 120 and has a cam head including a ramp formed along its circumference, a shaft 110, which is coupled to the fixing cam 140 such that the shaft 110 can rotate with the fixing cam 140, a torsion spring 150, of which each end is coupled to the fixing cam 140 the shaft 110, respectively, a sliding cam 130, which is coupled to the shaft 110 such that the sliding cam 130 is allowed to slide along the axial direction and has a protrusion against the ramp such that the movement of the shaft 110 can be selectively restricted, and a compression spring 152, which is interposed between the sliding cam 130 and the shaft 110 so as to compress the sliding cam 130 toward the fixing cam 140. The folder unit 2 can be coupled to the housing 120, and the base unit can be coupled to both ends of the shaft 110.

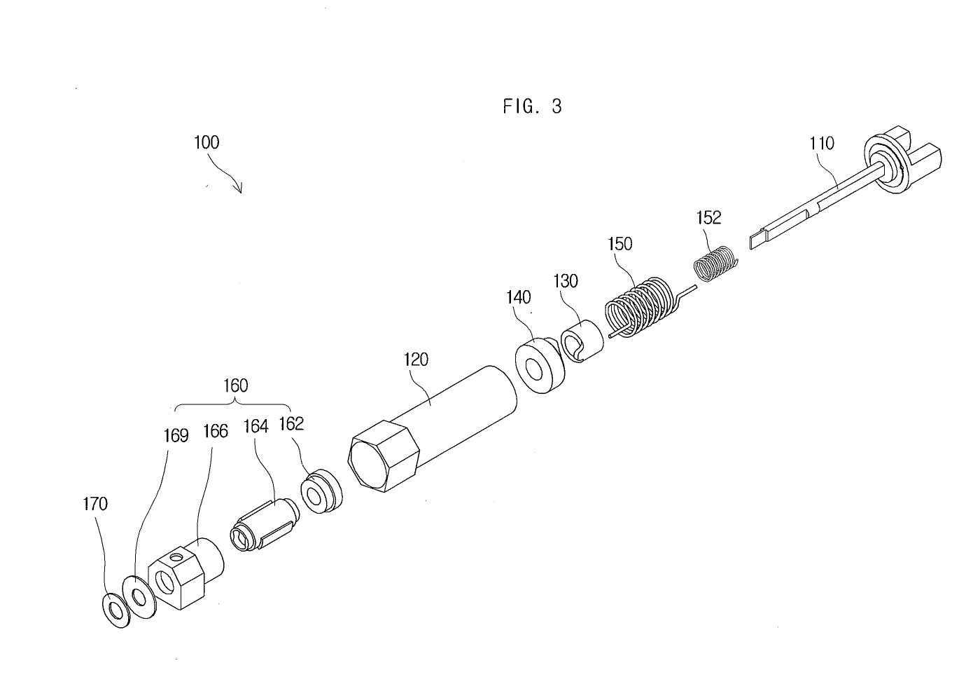

FIG. 3 is an exploded perspective view of the hinge assembly in accordance with an embodiment of the present invention. As illustrated in FIG. 3, the inside of the housing 120 can be shaped like a hollow cylinder such that the other elements comprising the hinge assembly 100 can be housed.

The fixing cam 140 can be coupled to the housing 120 by being housed in the housing 120. A through-hole can be formed in the center of the fixing cam 140. The shaft 110 can pass through the through-hole to be coupled to the fixing cam 140 such that the shaft 110 can rotate with the fixing cam 140.

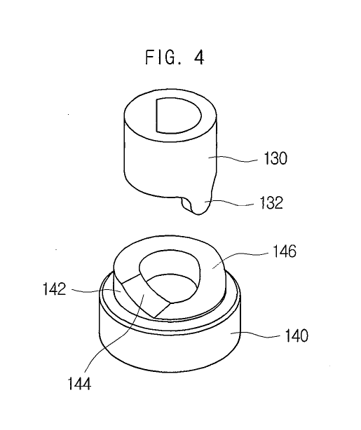

As illustrated in FIG. 4, a cam head 142 can be formed on one side of the fixing cam 140. The cam head 142 can be shaped like a ring that is protruded to one side of the fixing cam 140, and a ramp 144 can be formed on one side of the cam head 142 along the circumference of the cylinder. The ramp 144 can be a linear slope and functions as a stopper preventing a protrusion 132 of the sliding cam 130 from sliding along the cam head 142.

The cam head 142 can also have a curve 146 along its circumference. The curve 146 can be formed on the opposite side of the ramp 144 along the circumference of the cam head 142 and have a convexly curved surface. In other words, the cam head 142 of the fixing cam 140 encompasses the ramp 144 and the curve 146, which are provided to allow the protrusion 132 of the sliding cam 130 to slide along the circumference.

One end of the shaft 110 can be extended lengthwise, and the other end can be shaped like a bushing such that the shaft 110 can be coupled to the base unit 1. The lengthwise end of the shaft 110 can be inserted into the through-hole of the fixing cam 140 and coupled to the fixing cam 140 such that the shaft 110 can be rotated with the fixing cam 140. As a result, the shaft 110 can be connected to and rotate with respect to the housing 120. In addition, the lengthwise end of the shaft 110 can pass through the housing 120 and a damper 160, and both ends of the shaft 110 can be exposed to both ends of the hinge assembly 100 such that the shaft 110 can be coupled to the base unit 1. Each end of the torsion spring 150 can be coupled to the fixing cam 140 and the shaft 110, respectively. The torsion spring 150 can a coil spring and the like and provide a torque in a predetermined by being pre-rotated circumferentially.

Each end of the torsion spring 150 is coupled to the fixing cam 140 and the shaft 110, respectively, which are coupled to each other and rotate with respect to each other, providing the torque such that the fixing cam 140 can rotate in a predetermined direction with respect to the shaft 110. This torque can be delivered to the folder unit 2 through the housing 120, and thus the folder unit 2 can be subjected to the torque with respect to the base unit 1 in the direction of unfolding. As a result, the user can unfold the folder unit 2 of the mobile communication terminal 1000 more easily.

The sliding cam 130 can be coupled to the shaft 110 by sliding over the shaft 110 along the axial direction of the shaft 110. The cross section of the inside of the sliding cam 130 can be shaped like a letter “D,” and the cross section of some portion in the center of the shaft 110 can correspond to this “D” shape.

Therefore, the sliding cam 130 can be slid over the shaft 110 in the axial direction but cannot rotate irrespectively of the shaft 110. The compression spring 152 can be interposed between the sliding cam 130 and the shaft 110 and provide an elastic force lengthwise. The compression spring 152 can be pressed against the sliding cam 130 at one end and the shaft 110 at the other end. The compression spring 152 can, therefore, elastically press the sliding cam 130 toward the fixing cam 140 such that the sliding cam 130 and the fixing cam 140 maintain their contact and slide against each other.

As illustrated in FIG. 4, one side of the sliding cam 130 can have the protrusion 132, which is protruded against the fixing cam 140. As the shaft 110 rotates, the protrusion 132 of the sliding cam 130 can slide over the cam head 142 of the fixing cam 140 in the radial direction.

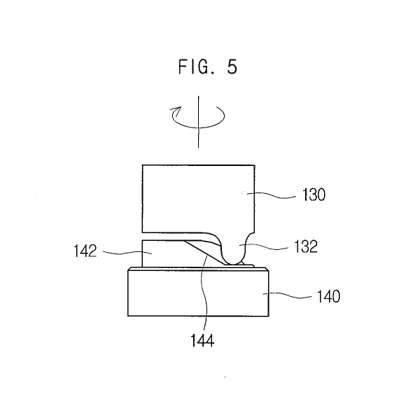

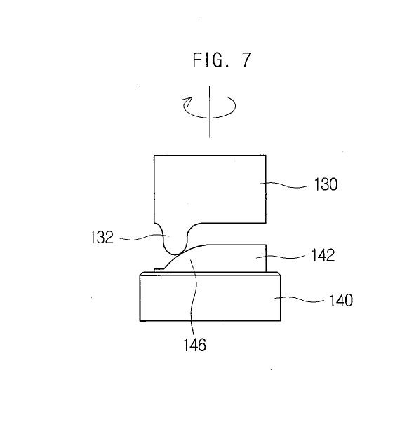

FIG. 5 through FIG. 7 are front views illustrating how the sliding cam 130 and the fixing cam 140 are operated in accordance with an embodiment of the present invention. As illustrated in FIG. 5, in case the folder unit 2 is folded, the protrusion 132 of the sliding cam 130 can be caught by the ramp 144 of the cam head 142.

Although the shaft 110 is always subjected the torque in the direction of unfolding the folder unit 2 with respect to the housing 120, the folder unit 2 can remain folded without a particular fixing configuration since the protrusion 132 of the sliding cam 130 is caught by the ramp 144 of the cam head 142.

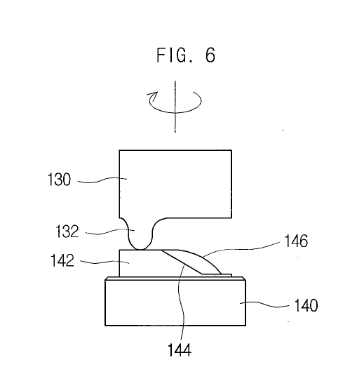

When a user desires to open the folder unit 2 in order to use the mobile communication terminal 1000, the user may apply a force on the folder unit 2 in the opening direction of the folder unit 2. The force can allow the protrusion 132 of the sliding cam 130 to ascend along the ramp 144 and rotate along the cam head 142 in the radial direction, as illustrated in FIG. 6.

Once the protrusion 132 of the sliding cam 130 escapes the ramp 144 of the cam head 142, the folder unit 2 can be unfolded by the torque provided by the torsion spring 150. When the protrusion 132 of the sliding cam 130 rotates and arrives at the curve 146 of the cam head 142, the protrusion 132 of the sliding cam 130 descends along the curve 146, completing the opening of the folder unit 2.

While the folder unit 2 is in an unfolded state, the protrusion 132 of the sliding cam 130 is retained at the curve 146 and can ascend along the curve 146 only if a predetermined amount of force or more is provided. For that reason, while the folder unit 2 is in an unfolded state, the curve 146 acts as a stopper for maintaining the folder unit 2 in the unfolded state.

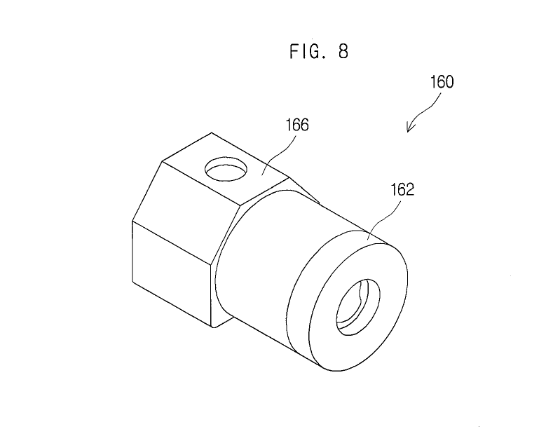

Therefore, the protrusion 132 of the sliding cam 130 can maintain the folded or unfolded state of the folder unit 2 by being restrained at the ramp 144 or the curve 146 as the protrusion 132 rotates along the cam head 142 of the fixing cam 140 in the radial direction. Here, the folded or unfolded state of the folder unit 2 can be released only if the folder unit 2 is applied with a force that is sufficient to have the protrusion 132 of the sliding cam 130 escape the ramp 144 or the curve 146. As a result, the ramp 144 or the curve 146, formed on the cam head 142 of the fixing cam 140, can selectively control the rotating of the sliding cam 130. FIG. 8 is a perspective view of the damper 160 in accordance with an embodiment of the present invention. As illustrated in FIG. 8, the damper 160 can be interposed between the shaft 110 and the housing 120 such that a rotation speed of the shaft is dampened.

When the user applies a force on the folder unit 2 to unfold the folder unit 2, the damper 160 can dampen the force exerted on the shaft 110 and the housing 120 by the force applied on the folder unit by user and the force exerted by the torsion spring 150, such that the folder unit 2 is unfolded in a smooth, soft motion.

The smooth, soft motion of unfolding the folder unit 2 can prevent an impact where the base unit 1 and the folder unit 2 collide when unfolding of the folder unit 2 is completed.

Moreover, when the user folds the folder unit 2, the force applied by the user can be dampened, preventing the folder unit 2 and the base unit 1 from colliding too hard.

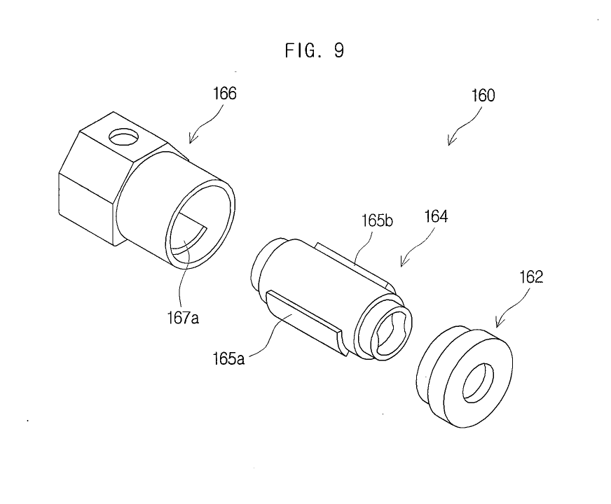

FIG. 9 is an exploded perspective view of the damper 160 in accordance with an embodiment of the present invention. As illustrated in FIG. 9, the damper 160 can include a core 164, which is fixed on the shaft 110, a case 166, which accommodates the core 164 and is fixed in the housing 120, and viscous fluid (not illustrated), which is interposed between the core 164 and the case 166.

The cross section of the inside of the core 164 can be shaped in correspondence with the cross section of the portion of the shaft 110 that is inserted into the core 164. The case 166 can be shaped like a cylinder such that the core 164 is accommodated inside the case 166 and can be coupled to the housing 120.

The viscous fluid can be injected between the case 166 and the core 164. When the core 164 rotates inside the case 166, the viscous fluid provides friction between the core 164 and the case 166, slowing down the rotation between the core 164 and the case 166. The viscous fluid can be a hyper viscous fluid, for example, grease or silicon oil. The case 166 can also include a cover 162 such that a viscous fluid is prevented from leaking.

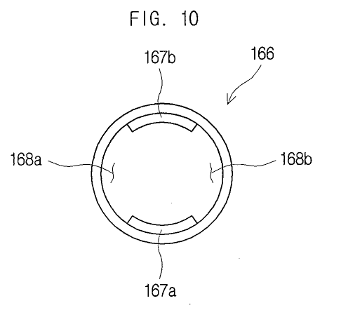

Formed on the outer surface of the core 164 can be blades 165a and 165b, which has friction with the viscous fluid and can enhance the dampening function of the damper 160 by hampering with the flow of the viscous fluid inside the case 168. FIG. 10 is a plan view of the case 166 in accordance with an embodiment of the present invention. As illustrated in FIG. 10, protruding units 167a and 167b can be formed on an inner wall of the case 166 where the blades 165a and 165b of the core 164 are not located or rotated.

Formed on the inner wall of the case 166 where the protruding units 167a and 167b are not located can be accommodating units 168a and 168b, in which the blades 165a and 165b can rotate. Like the blades 165a and 165b, the protruding units 167a and 167b can inhibit the flow of the viscous fluid and enhance the dampening function of the damper 160. According to certain aspects of the invention as set forth above, the rotating of the hinge assembly can be selectively controlled by using the cam structure, and a folder type mobile communication terminal can be maintained in a folded state using the structure.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

What is claimed is:

1. A hinge assembly comprising:
a housing;
a fixing cam coupled to the housing, the fixing cam having a cam head formed thereon, the cam head comprising a ramp being formed along a circumference;
a shaft coupled to the fixing cam such that the shaft and the fixing cam can rotate;
a torsion spring coupled to the fixing cam on one end and the shaft on the other end;
a sliding cam coupled to the shaft such that the sliding cam is allowed to slide over the shaft along the axial direction and including a protrusion facing the ramp; and
a compression spring interposed between the sliding cam and the shaft such that the sliding cam is compressed toward the fixing cam.

2. The hinge assembly of claim 1, wherein the cam head comprises a curve formed along the circumference.

3. The hinge assembly of claim 1, further comprising a damper interposed between the shaft and the housing such that rotation of the shaft is dampened.

4. The hinge assembly of claim 3, wherein the damper comprises:
a core fixed on the shaft;
a case accommodating the core and fixed in the housing; and
viscous fluid interposed between the core and the case.

5. The hinge assembly of claim 4, wherein a blade is formed on an outer surface of the core, the blade having friction with the viscous fluid.

6. A mobile communication terminal comprising:
a base unit;
a folder unit coupled to the base unit such that the folder unit and the base unit can rotate; and
a hinge assembly interposed between the base unit and the folder unit such that the base unit and the folder unit are coupled to each other and rotate,
wherein the hinge assembly comprises:
a hosing;
a fixing cam coupled to the housing, the fixing cam having a cam head formed thereon, the cam head comprising a ramp being formed along a circumference;
a shaft coupled to the fixing cam such that the shaft and the fixing cam can rotate;
a torsion spring coupled to the fixing cam on one end and the shaft on the other end;
a sliding cam coupled to the shaft such that the sliding cam is allowed to slide over the shaft along the axial direction and including a protrusion facing the ramp; and
a compression spring interposed between the sliding cam and the shaft such that the sliding cam is compressed toward the fixing cam.

7. The mobile communication terminal of claim 6, wherein the cam head comprises a curve formed along the circumference.

8. The mobile communication terminal of claim 6, further comprising a damper interposed between the shaft and the housing such that rotation of the shaft is dampened.

9. The mobile communication terminal of claim 8, wherein the damper comprises:
a core fixed on the shaft;
a case accommodating the core and fixed in the housing; and
viscous fluid interposed between the core and the case.

10. The mobile communication terminal of claim 9, wherein a blade is formed on an outer surface of the core, the blade having friction with the viscous fluid.
